(19) United States
(12) Patent Application Publication
(10) Pub. No.: US 2017/0110156 A1
(43) Pub. Date: Apr. 20, 2017

(54) SYSTEM AND METHOD FOR COLLABORATIVE ANNOTATIONS OF STREAMING VIDEOS ON MOBILE DEVICES

(71) Applicant: Freshdesk, Inc., San Bruno, CA (US)

(72) Inventors: Vineet MARKAN, Pune (IN); Rohit AGARWAL, Delhi (IN)

(73) Assignee: Freshdesk, Inc., San Bruno, CA (US)

(21) Appl. No.: 15/309,384

(22) PCT Filed: May 18, 2015
(86) PCT No.: PCT/IN2015/000211

§ 371 Date: Nov. 7, 2016

Related U.S. Application Data
(60) Provisional application No. 62/000,016, filed on May 19, 2014.

(51) Int. Cl. G11B 27/34; G06F 3/0488; G11B 27/036

(52) U.S. Cl. CPC G11B 27/34; G11B 27/036; G06F 3/04883

(57) ABSTRACT

A system and method to enable fine-grained, contextual annotations of streaming videos by one or more users, prioritizing the use of screen space on mobile devices by allowing users to draw or place threaded comments while utilizing a touch-based interface, reducing distractions caused by a* cluttered interface. By enabling the user to control annotations beginning at a particular timestamp within the streaming video, the present invention optimizes screen real estate on mobile devices efficiently. Contextual commenting is enabled using a combination of perspectives, which highlight the parts of the video being annotated, while dimming out the rest of the screen elements and flexible extension of a user's comments across one or many frames of the streaming video. Using a simple touch-based interface the present invention is intuitive and further enables the user to select the vicinity around which he or she wishes to increase sensitivity or have finer control.

### BACKGROUND OF THE INVENTION

Field of the Invention

This invention relates to video annotation systems, and more particularly to a collaborative, mobile-Used model which can annotate videos over single or a range of frames.

Discussion of Prior Art

Streaming video is a ubiquitous part of the World Wide Web today for a number of end-uses. The ability to view content necessitates annotation of the content with contextual markers, in order to enable asynchronous collaboration across groups of users. Several domains exhibit the need for annotations for collaborative use, including education [1] and research. With the growing proliferation of Mobile devices including smartphones and tablets, with increasingly touch-based interfaces, screen real estate is at a premium. For example, Google has built an annotation system for the World Wide Web for YouTube, but the video gets very limited space on screen. With this tool, most of the space is occupied either by the annotation timeline or the markup tools. Usability is increasingly important with mobile devices and applications that are ultimately considered to have any longevity, utilize this as a key benchmark.

U.S. Pat. No. 8,566,353 B2 titled “Web-based system for collaborative generation of interactive videos” describes a system and method for adding and displaying interactive annotations for existing videos, hosted online. The annotations may be of different types, which are associated with a particular video. Even the authentication of the user to perform annotation of a video can be done in one or more ways like checking a uniform resource locator (URL) against an existing list, checking a user identifier against an access list, and the like. A user is, therefore accorded the appropriate annotation abilities.

U.S. Pat. No. 8,510,646 B1 titled “Method and system for contextually placed chat-like annotations” describes a method and system for contextually placed annotations where the users can add one or more time-stamped annotations at a selected location in the electronic record. The system enables the user to share the discussion window content with other users vide email and request for alerts on one or more successive annotations. This electronic record can reside on a server and is updated repeatedly reflecting current content.

US 20130145269 A1 titled “Multi-modal collaborative web-based video annotation system” describes an annotation system which provides a video annotation interface with a video panel configured to display a video, a video timeline bar including a video play-head indicating a current point of the video that is being played, a segment timeline bar including initial and final handles configured to define a segment of the video for playing, and a plurality of color-coded comment markers displayed in connection with the video timeline bar. Each of the users can make annotations and view annotations made by other users and these include annotations corresponding to a plurality of modalities, including text, drawing, video, and audio modalities.

There are a very few applications in the prior art, which are specifically targeted to solve the problem of video annotations on mobile devices. None of these apps address the problem of annotating a range of frames in a collaborative environment. Coach Eye by Techsmith Corp. is meant for sports coaches to review the performance of athletes and sportsmen via recorded sessions. They allow users to draw on top of video using a set of drawing tools though these drawings are not associated with any range of frames and overlay the whole video. They allow users to export these videos with annotations burnt in along with user's voice and share it with other users in video format. It's also worth noting that they implement an interesting flywheel pattern to allow users to advance through the video with frame accurate precision. This pattern works well for short videos but struggles with lengthier videos. This model of collaboration is quite different from the one addressed by our invention.

### SUMMARY OF THE INVENTION

A system and method to enable fine-grained, contextual annotations of streaming videos by one or more users, prioritizing the use of screen space on mobile devices by allowing users to draw or place threaded comments while utilizing a touch-based interface, reducing distractions caused by a cluttered interface. By enabling the user to control annotations start at a particular timestamp within the streaming video, the present invention optimizes screen real estate on mobile devices efficiently. Contextual commenting is enabled using a combination of perspectives, which highlight the parts of the video being annotated, while dimming out the rest of the screen elements and flexible extension of a user's comments across one or many frames of the streaming video. Using a simple touch-based interface the present invention is intuitive and further enables the user to select the vicinity around which he or she wishes to increase sensitivity or have finer control. One or more users organized at different hierarchies and groups can collaboratively annotate the same video, their comments being crisply displayed as a list to avoid overlapping comments (at the same part of the timeline) from contusing the effort. Further, the present invention allows individual users to approve the finality of their comments and retains a proactive approach that works with elements of die touch-based interface.

Videos have a generic linear timeline in most of media players. The present invention features a seek bar by default. Assuming the user is reviewing a 5 minute clip and the length of the seek bar is 400 pixels, this translates to 300 seconds of content or 300*24 frames (assuming 24 fps video) being represented by 400 pixels. In other words, (300*24)/400 or 18 frames are being represented by every pixel. Thus, on such a timeline it becomes very difficult for the user to seek to the exact frame up to which he wants the comment to last. Contrary to this, if timeline is designed at the frame accurate granularity, it becomes rather tedious to annotate a bigger range of frames as the length of video increases. Consequently, there is a need to dynamically adjust the timeline sensing what the user wants to achieve.

This invention discloses a computer implemented method and system for fine-grained, contextual annotation of streaming video by one or more users, optimizing the use of screen space on mobile devices wherein one or more users represent annotations on the video's timeline by creating one or more markers. The user hard-presses to select a vicinity within the video over which he seeks finer control on playback or reduced sensitivity; approves his annotation by means of a submit button; and views a crisp, list-based view of the collaborative annotations at the same point whhin the video's timeline.

The user is enabled to represent annotations on the video's timeline by the creation of one or more markers, comments and metadata wherein the user is enabled to pause the video at a particular timestamp, as desired. The user selects a comment tool and switches to comment mode, within the execution environment and a combination of perspectives highlight his selection of the start of the video-frames over, which he is annotating with his comments. The user enters his comment in the comment box and extends his comment to a larger range of frames than in his original selection, using a dragging action—which is typically a single figure gesture.

The desired finer control on playback or reduced sensitivity is achieved by the user while selecting vicinity within the video by zooming-in to particular portions of the video's timeline and moving forward and backward in time by a small realizable movement of the hand on the time-line.

The user finally approves his annotation after the system has checked for the existence of prior annotations that lie within a specific interval of that timestamp. In the event of pre-existing comments, the system adds the comment associated with this instance of the annotation to a list associated with the nearest marker. This process further indicates the change in the User Interface with a blinking marker. In the event of no pre-existing comments, a new marker is created with a unique user-image for die user that has added the comment.

The user also views collaborative annotations at the same point within the video's timeline following one or more steps, such that, he taps on a marker on the video's timeline, wherein the marker denotes one or more comments. In the event of a marker denoting a single comment, the system navigates to the beginning of the range of frames with which the comment is associated and expands the comment to allow the user to view its contents over one or more frames. In the event of a marker denoting more than one comment, the system presents the user with a linear list of comments within that group, and auxiliary comments on that frame and other frames in the vicinity. The system finally accepts the user's choice on which comment he wishes to view and displays the details.

### BRIEF DESCRIPTION OF THE DRAWINGS

FIG. 1 shows the process flow of creating contextual comment on one or more frames.

FIG. 2 shows a view of user long taps on the screen at a point where can drop a comment.

FIG. 3 shows a view of the comment text box in the center of the screen seen above a user's touch keyboard.

FIG. 4 is an extension to FIG. 3 showing the state of video timeline while user is inputting the comment.

FIG. 5 shows a view to extend a contextual comment over multiple frames in the video.

FIG. 6a shows a user actively adjusting the range of frames he wants to annotate by dragging marker on timeline.

FIG. 6b shows the state where user hard presses on marker to fine-tune his selection. A zoomed version of the timeline begins to fade-in.

FIG. 6c shows the zoomed in version of the timeline where user can comfortably make a smaller adjustment in his selection.

FIG. 7 shows a view of the final form of the saved comment appearing on the screen.

FIG. 8 shows the process for creating markers on the timeline.

FIG. 9 shows the process for viewing comments via markers on the timeline.

FIG. 10 shows a view of a linear list of comments within the group cm one or more frames in vicinity.

FIG. 11 shows a view of the timeline highlighting the comments existing on a range of frames.

FIG. 12 shows an example illustrating any comments that lie within (2*r*t)/l seconds are detected for circular markers.

FIG. 13 shows an example illustrating how groups/users interact with database and servers.

FIG. 14 shows an example illustrating hierarchy of users, files and annotations within a group.

### DETAILED DESCRIPTION OF PREFERRED EMBODIMENTS

The following Figures outline the preferred embodiments in greater detail. A person skilled in the art would be able to appreciate that if a system is designed such that only form of annotation allowed is textual commenting, there is no need for an explicit comment tool, live user can simply pause the video and do a long tap on top of it to drop the comment. The form of marker used here is a circular marker, the rationale here is that finger impression on a touch screen can be roughly approximated as a circular shape; other shapes such as rectangular and elliptical shapes can also be used here.

Frame accurate commenting can also be achieved by switching the timeline between two different modes. In this invention, we switch to frame accurate mode when user hard presses the timeline and come back to normal mode when he releases the pressure. A similar effect can be achieved by using a toggle switch button which changes the timeline to a zoomed in filmstrip mode and back to a linear mode.

The users in the system of the present invention are divided into groups such that members of these groups share content privately with each other. Each user can belong to more than one group and can access content shared among these groups. Various levels of permissions can be implemented within a group. Users can create new groups and invite more people to their groups. Users are authenticated either by their email/password or by using OAuth on a service they are already using such as Google or Facebook accounts. Users can create groups and invite other members to their group. Permissions such as who can annotate the video and who can invite other people or approve comments are flexible. Data is sent to the servers using a socket implementation, which maintains a persistent connection with the server, also enabling minimum overhead involved in the request and response cycle. While synchronizing data with other users, the push capability of sockets is utilized to achieve near real time data synchronization among online users. Persistent data is stored in the database server while all the session data is held by app server.

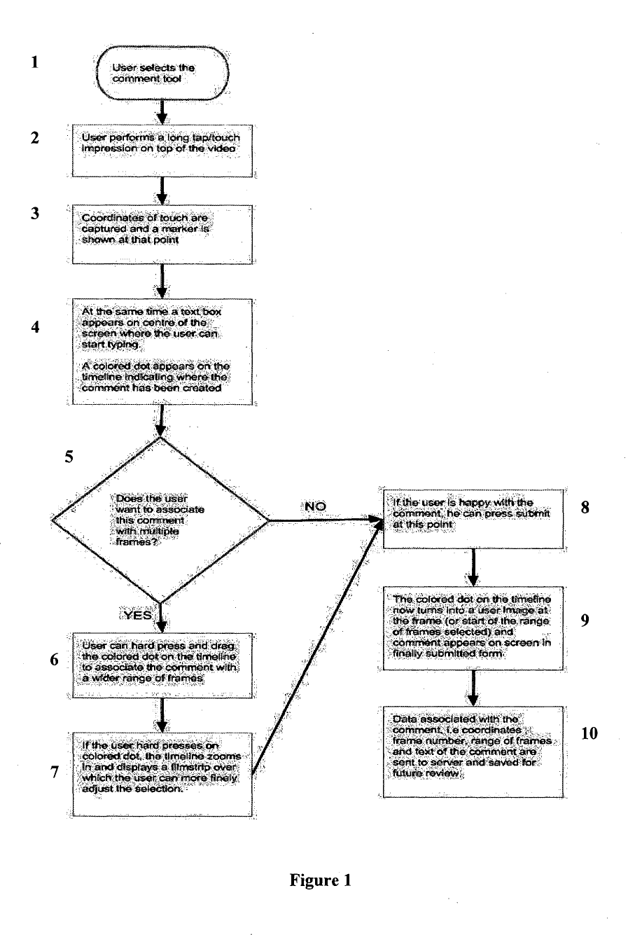

FIG. 1 shows the process flow of creating contextual comment on one or more frames, which is initiated as and when the user selects the comment tool 1. The user can perform a long tap/touch impression on top of the video 2 and the coordinates of touch are captured and a marker is shown at that point 3. At the same time, a text box appears on the center of the screen where the user can start typing and give comments. A colored dot appears on the timeline indicating where the comment has been created 4. The user is given the option to associate this comment with one or more frames 5. If the user wants to associate the comment with one or more frames he can hard press and drag the colored dot on the timeline to associate the comment with a wider range of frames 6. Due to this action the timeline zooms in and displays a filmstrip over which the user can more finely adjust the selection 7. If the user is happy with the comment 7 or doesn't want to associate the comment with multiple user 5, he can press the submit button 8. The colored dot on the timeline then turns into a user image at the frame or start of the range of frames selected and comment appears onscreen in finally submitted form 9. The data associated with the comment, i.e., coordinates, frame number, range of frames and text of the comments are then sent to the server and stored for future review 10.

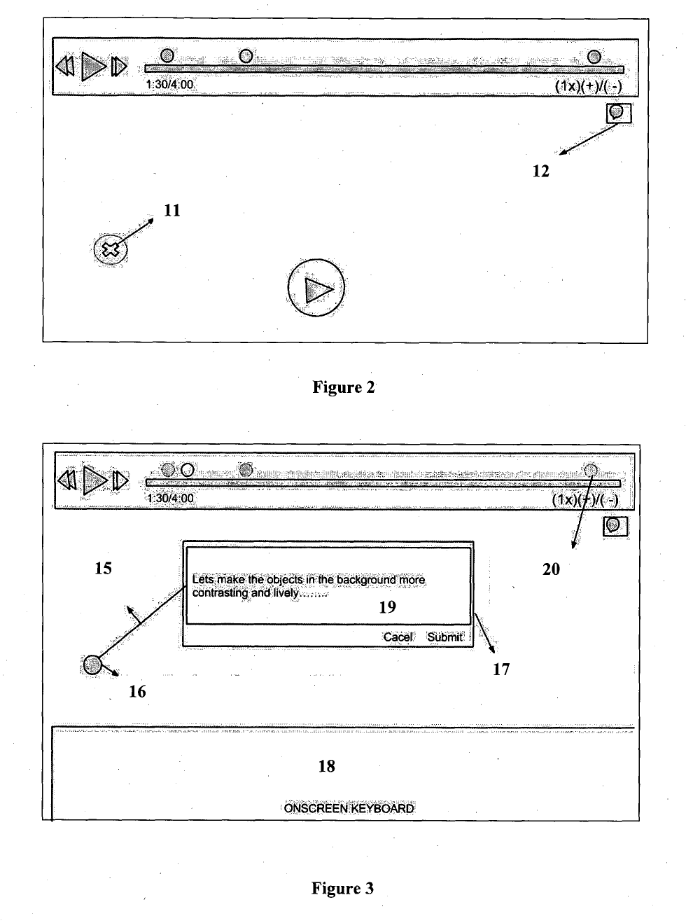

FIG. 2 shows a view of the point where user long taps on screen and drop a comment. The user can select the comment tool 12 when he wants to leave an annotation. The user long taps/makes an impression at the point 11 as shown.

FIG. 3 shows a view of the comment text box 19 in the centre of the screen seen above onscreen keyboard 18. Once the user had made an impression on screen 16, a comment box 19 appears on the center of the stage, connected to the marked spot 16 vide a line 15. The previous comments are dimmed out at this point to gain focus on active timeline marker 20.

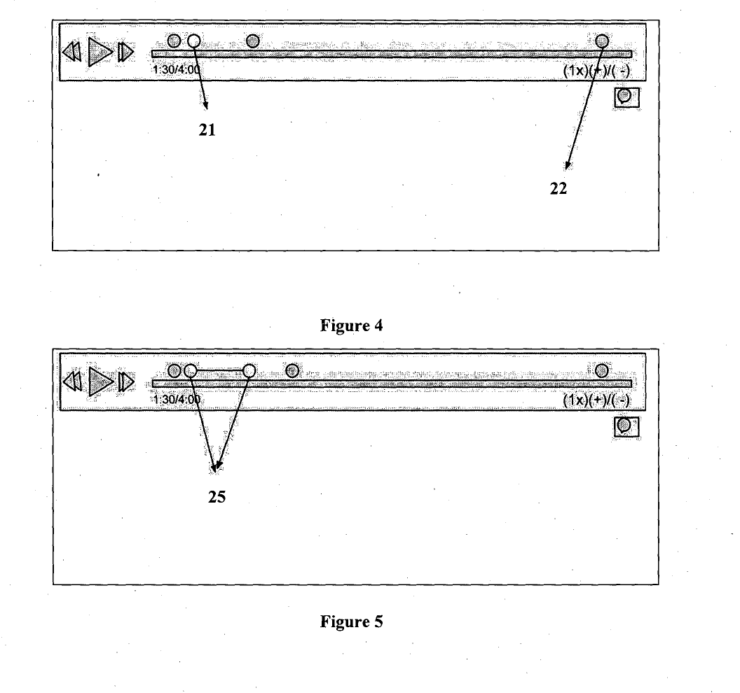

FIG. 4 is an extension to FIG. 3 showing the state of video timeline while user is inputting the comment. It shows the colored marker that appears on the timeline indicating where the comment has been dropped 21. User can drag this point to split it into two such that these two points represent a range of frames being annotated. The user images are also seen that denote comments that have been previously submitted by various users 22.

FIG. 5 shows a view to extend a contextual comment over multiple frames in the video. Either of the two points 25 can be adjusted to get the desired range of frames. While the user is adjusting the markers on timeline, he can touch at any point between the markers or on markers themselves. In such an event video seeks to the time, which is represented by that point in the timeline. The video seeks to the point where the dot/marker is being adjusted so user can see the frames being annotated.

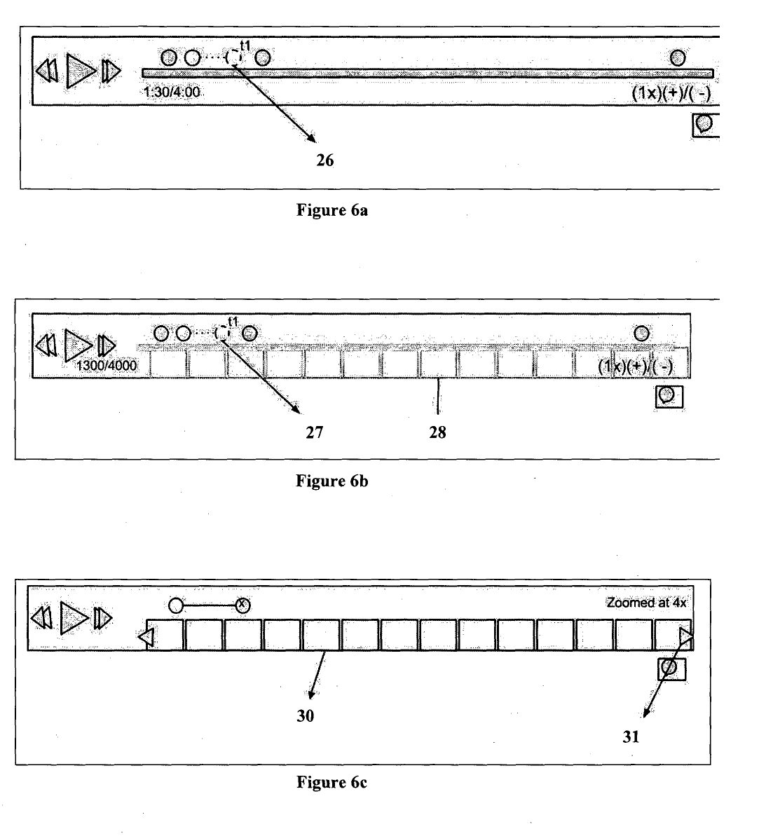

FIG. 6a shows a user actively adjusting the range of frames he wants to annotate by dragging marker on timeline. When the user wishes to select a narrow range of frames, he can stop dragging the marker near this point 26.

FIG. 6b shows the state where user hard presses on marker to finetune his selection. User hard presses the marker point thus indicating he wants to make a finer selection 27. The timeline begins to zoom in such that linear timeline begins to fade out as the user hard presses timeline marker. In its place, a series of video frames begin to fade-in 28. This new form of the timeline has a lesser sensitivity compared to previous form to give user a more fine-grained control on seeking.

FIG. 6e shows the zoomed in version of the timeline where user can comfortably make a smaller adjustment in his selection 30. Users can navigate through the video with frame accurate control during this time by Finely adjusting the colored marker. Since the filmstrip view is bigger than its container, it scrolls when it approaches the horizontal end of the view 31.

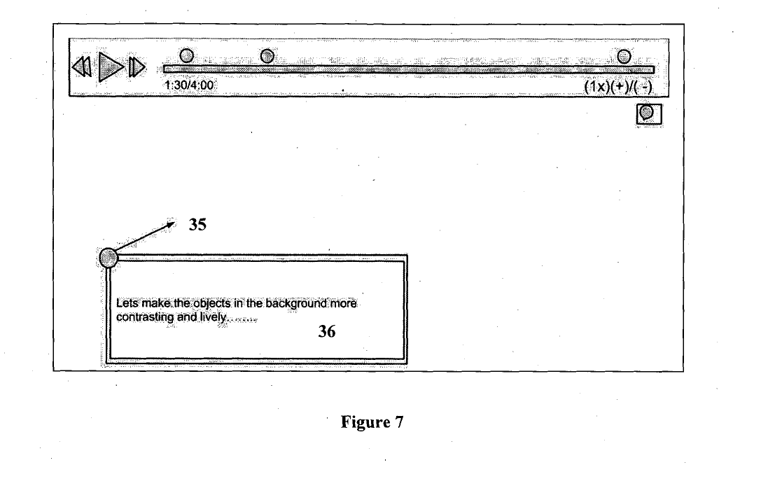

FIG. 7 shows a view of the final form of the saved comment appearing on the screen 36. The colored dot changes to the image of the user who submitted the comment 35. Tapping on this image collapses the comment.

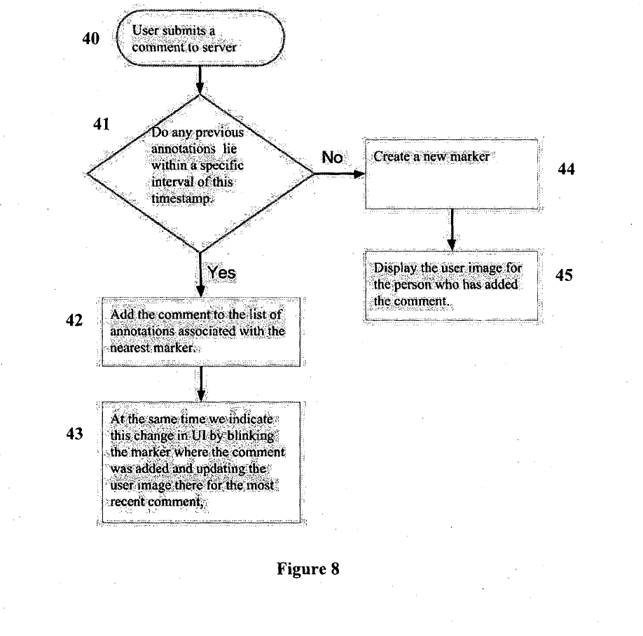

FIG. 8 shows the process for creating markers on the timeline. Once the user submits the comment to server 40, the system checks if there are any prior comments/annotations that lie within a specific interval of the timestamp 41. A comment is added to the list of annotations associated with the nearest marker 42 and this change is indicated in UI by blinking the marker where the comment was added and updating the user image here for the most recent comment 43, if there are any prior comments/annotations lying within a particular interval of the timestamp 41. If no comments/annotations lie within a particular interval of the timestamp 41, a new marker is created 44 and the user image for the person who has added the comment is displayed 45.

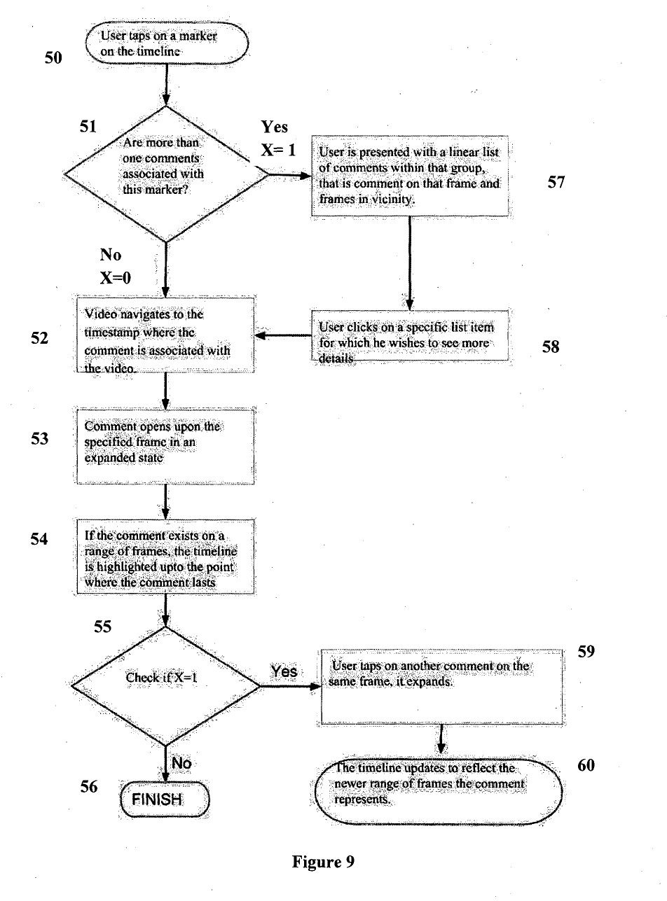

FIG. 9 shows the process for viewing comments via markers on the timeline where the user taps on a marker on the timeline 50 that may mean a single comment or more than one comment. The system checks if more than one comment is associated with the marker 51. If the marker denotes one or more comments, video navigates to the timestamp where live comment is associated with the video 52. The comment opens on the stage in expanded state such that its contents can be viewed 53. If the comment exists on a range of frames, the timeline is highlighted up to the point where the comment lasts 54. The system then checks if more than one comment is associated with this marker 55. If the marker denotes a single comment, the process of viewing the comments is stopped 56. If more than one comment exists on this frame and user taps on another comment on the same frame, it expands 59. Also, the timeline updates to reflect the newer range of frames the comment represents 60. If the marker denotes a single comment 51, the user is presented with a linear list of comments within that group that is the comment on that frame and frames in vicinity 57. The user then clicks on a specified list item for which he wishes to see more details 58.

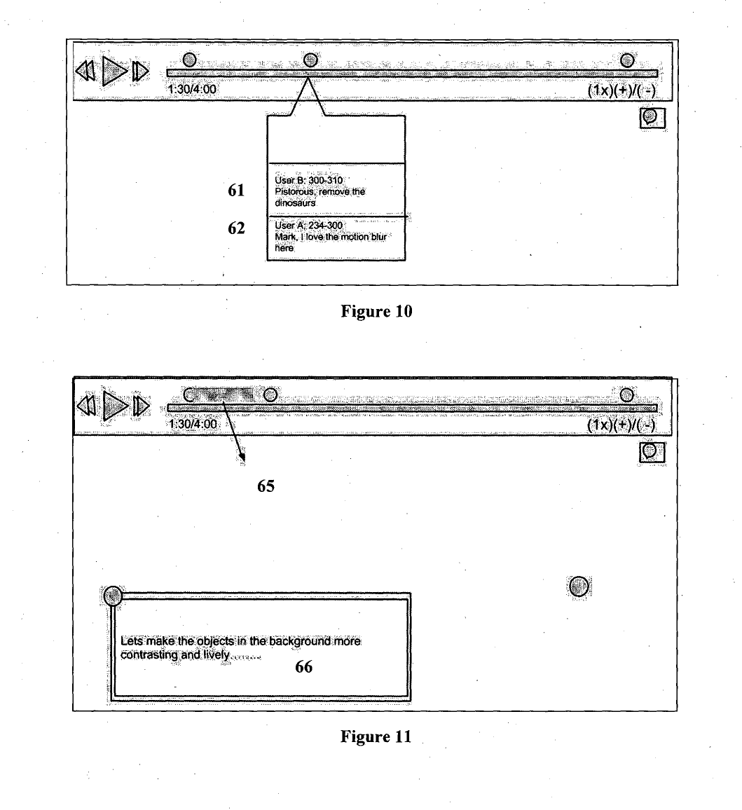

FIG. 10 shows a view of a linear list of comments within the group on one or more frames in vicinity. Eg: (a) User B; 300-310 Pistorous, remove the dinosaurs 61; and (b) User A; 234-230 Mark. I love the motion blur here 62.

FIG. 11 shows a view of the timeline 65 highlighting the comments existing on a range of frames 66. When the user expands a different annotation, the range will change.

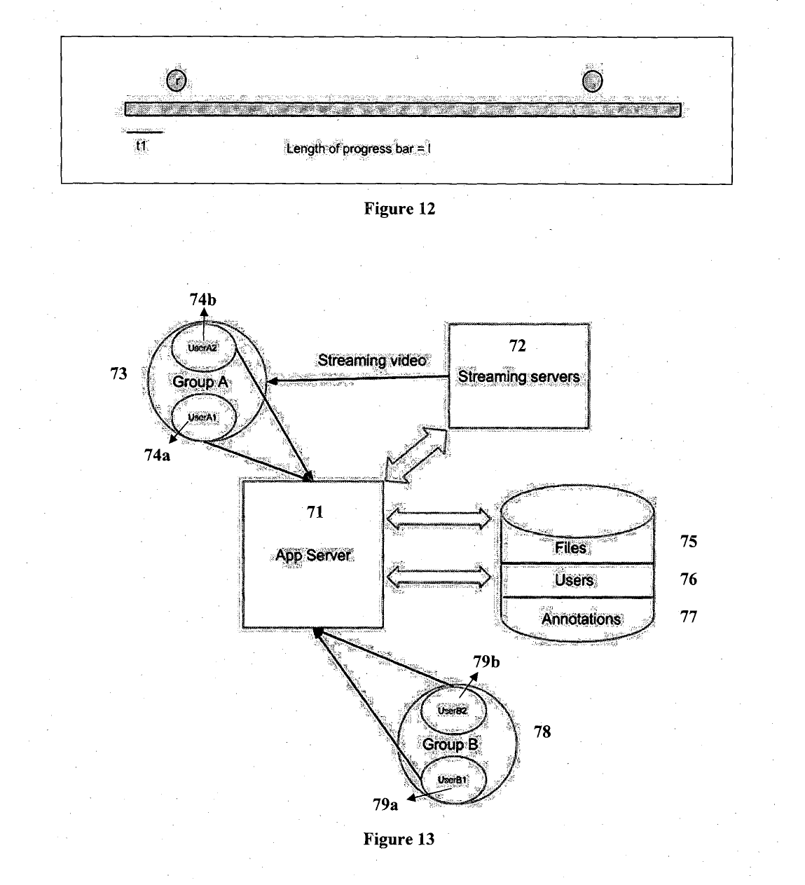

FIG. 12 shows an example illustrating any comments that lie within (2*r*t)/l seconds are detected for circular markers.

FIG. 13 shows an example illustrating how groups/users interact with database and servers. The App server 71 is interconnected with the streaming servers 72 and database having files 75, user details 76 and one or more annotations 77. The App server 71 also receives information from two types of users. Group A 73 comprising of user A1 74a and user A2 74b and Group B 78 comprising user B1 79a and user B2 79b. The Streaming server 72 streams video for Group A users 73.

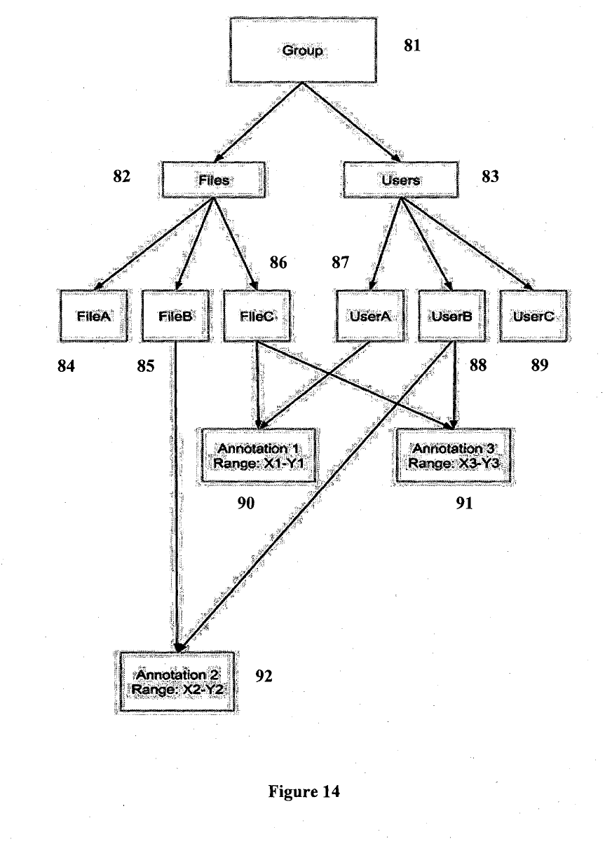

FIG. 14 shows an example illustrating hierarchy of users, files and annotations within a group. A group 81 comprises of files 82 and users 83. There are one or more files—File A 84, File B 85, File C 86 in the files group 81 and one or more users—User A 87, User B 88 and User C 89 in the users' group 83. The different users and files details form one or more types of Annotations as Annotation 1 with Range X1-Y1 90 is created with File C and User A details, Annotation 3 with Range X3-Y3 91 is created with File C and User B details and Annotation 2 with Range X2-Y2 92 is created with File B and User B details.

### REFERENCES

1. Davis, and Huttonlocker, CoNote System Overview. (1995) Available at http://www.cs.cornell.edu/home/dph/annotation/annotations.html.
2. Smith. B. K., and Reiser. B. J., What Should a Wildebeest Say? Interactive Nature Films for High School Classrooms, Proceedings of ACM Multimedia '97 (Seattle, Wash., USA, November 1997), ACM Press, 193-201.

1. A computer implemented method for fine-grained, contextual annotation of streaming video by one or more users, optimizing the use of screen space on mobile devices comprising the steps of:
a. Enabling the user to represent annotations on the video's timeline by creating one or more markers 4;
b. Enabling the user, by means of a hard-press action, to select a vicinity within the video over which he seeks finer control on playback or reduced sensitivity 7;
c. Enabling the user to approve his annotation by means of a submit button 8; and
d. Enabling a crisp, list-based view of collaborative annotations at the same point within the video's timeline 9.

2. A computer implemented method of claim 1 wherein the user is enabled to represent annotations on the video's timeline by the creation of one or more markers, comments and metadata further comprising the steps of:
a. Enabling the user to pause the video at a particular timestamp, as desired;
b. Enabling the user to select a comment tool 12 and switching to comment mode, within the execution environment 11;
c. Enabling a combination of perspectives to highlight the user's selection of the start of the video-frames over 16, which he is annotating with his comments;
d. Enabling the user to enter his comment in a comment box 19, 21; and
e. Enabling the user to extend his comment to a larger range of frames than in his original selection, using a dragging operation 25.
f. A computer implemented method of claim 1 wherein the user is enabled to select a vicinity within the video over which he seeks finer control on playback or reduced sensitivity 27. Further, enabling the user to zoom in to particular portions of the video 28, while simultaneously allowing the user to move forward and backward in time by a small realizable movement of the user's hand on the time-line 30.

3. A computer implemented method of claim 1 wherein the user is enabled to approve his annotation further comprising the steps of:
a. The system checking for the existence of prior annotations that lie within a specific interval of that timestamp 41;
b. In the event of pre-existing comments, adding the comment associated with this instance of the annotation to a list associated with the nearest marker 42, further indicating this change in the User Interface with a blinking marker 43;
c. In the event of no pre-existing comments, creating a new marker 44 with a unique user-image for the user that has added the comment 45; and
d. Checking if the user has added the marker lines at the beginning or end of the timeline.

4. A computer implemented method of claim 1 wherein the user is enabled to view collaborative annotations at the same point within the video's timeline further comprising the steps of:
a. The user tapping on a marker on the video's timeline 50, wherein the marker denotes one or more comments;
b. In the event of a marker denoting a single comment 51, the system navigating to a point in the video where the comment is associated with a part of the video's timeline 52;
i. Opening the comment to allow the user to view its contents over one or more frames 53;
c. In the event of a marker denoting more than one comment 51:
i. Presenting the user with a linear list of comments within that group, commenting on that frame and other frames in the vicinity 57;
d. Accepting the user's choice on which comment he wishes to view and displaying the details 58.

5. A computer implemented system for fine-grained, contextual annotation of streaming video by one or more users, optimizing the use of screen space on mobile devices comprising:
a. Means to enable the user to represent annotations on the video's timeline by creating one or more markers 4;
b. Means to enable the user, by means of a hard-press action, to select a vicinity within the video over which he seeks finer control on playback or reduced sensitivity 7;
c. Means to enable the user to approve his annotation by means of a submit button 8; and
d. Means to enable a crisp, list-based view of collaborative annotations at the same point within the video's timeline 9.
